(19) United States
(12) Patent Application Publication
(10) Pub. No.: US 2012/0272504 A1
(43) Pub. Date: Nov. 1, 2012

(54) METHOD FOR FASTENING STRIPS TO LEISURE CHAIRS

(76) Inventors: Lausan Chung-Hsin LIU, Shanghai (CN); Shopo Hsin Tsu Liu, Shanghai (CN); Fibro Tsu Kun Liu, Shanghai (CN)

(21) Appl. No.: 13/094,430

(22) Filed: Apr. 26, 2011

(51) Int. Cl. B23P 11/02; B32B 37/06; B32B 37/02

(52) U.S. Cl. 29/447; 156/73.1

(57) ABSTRACT

A method for fastening strips to leisure chairs aims to fasten a plurality of strips to a frame of a leisure chair. The method includes the steps of: first, preparing the frame with two side tubes and a coupling tube to bridge one end of each side tube; bending inversely two ends of each strip towards the center and fastening the two ends to the strip to form respectively a coupling opening at the two ends; heating and softening the strip; coupling the softened strips on the two side tubes through the coupling openings; and finally bridging a support tube on another two ends of the two side tubes opposite to the coupling tube to stretch the strips coupled on the two side tubes to achieve supporting effect. The method makes assembly of the strips easier and increases production speed of the leisure chairs.

### FIELD OF THE INVENTION

The present invention relates to a method for fastening strips to leisure chairs and particularly to a method for fastening strips to a frame of a leisure chair.

### BACKGROUND OF THE INVENTION

These days increasing of living standard has made people to raise even higher expectation on life quality. To improve comfort and aesthetic appeal at home, many people don't hesitate to purchase various types of household goods, including a wide variety of furniture, such as sofas, chairs and the like. Chairs are some of indispensable furniture to provide comfort for people in the houses, offices and leisure activities.

There are myriad types of chairs on the market with different structures made according to different functions or requirements. Take leisure chairs for instance, R.O.C. patent No. 488244 provides a chair that can be stacked over one another. It mainly has a frame including a seat and a backrest with a plurality of elastic strips fastened to the frame so that resilient support can be provided to the back or the hip of a user to enhance comfort during sitting.

Referring to FIGS. 1 through 5, assembly of the aforesaid leisure chair mainly includes steps of: straddling transversely strips 20 on two side tubes 10 of the frame with corresponding fastening holes 11 and 21 formed respectively on the side tubes 10 and two distal ends of each strip 20 (as shown in FIG. 1); then inserting a fastening element 22 through the fastening holes 11 and 21. However, in practice, one distal end of the strip 20 is fastened firstly to one side tube 10 (referring to FIG. 2), and the strip 20 is wound a number of times to wrap the fastening holes 11 and 21 and the fastening element 22 to increase fastening strength. After winding, the strip 20 is stretched to another side tube 10 to wrap through another distal end of the strip 20 (referring to FIG. 3). The distal end of the strip 20 is wound on the inmost side (referring to FIG. 4) and is fastened through the fastening element 22 to make the wound structure at two sides symmetrical to form the finished leisure chair (as shown in FIG. 5). The aforesaid fastening approach tends to create the following problems:

1. In general, the distal ends of the strip is wound on the outmost layer, but the distal ends of the strip 20 of the aforesaid leisure chair is wound on the inmost layer during the second winding, which creates difficulty in assembly. As a result, production speed of the leisure chair is adversely affected.

2. Before winding of the strip 20 is performed for the second time, the strip 20 has to be stretched to the side tube 10 at another side. Every worker exerts different stretching forces, hence each strip 20 is stretched with various degree of forces. As a result, each strip 20 has different tensions that also affect sitting comfort and impact product quality.

### SUMMARY OF THE INVENTION

The primary object of the present invention is to solve the problems of the conventional method that winding and fastening strips to leisure chairs are difficult and time-consuming and also result in uneven tensions on the strips and impact sitting comfort.

To achieve the foregoing object, the present invention provides a method for fastening strips to leisure chairs that mainly includes steps of: first, preparing a plurality of strips and a frame of a leisure chair with two side tubes, each side tube including one end connected to a coupling tube; second, bending inversely two ends of each strip towards the center and fastening the two ends to the strip to form respectively a coupling opening at the two ends; third, heating and softening the strips; then coupling the softened strip on the two side tubes through the coupling openings; and finally bridging a support tube to another two ends of the two side tubes opposite to the coupling tube to stretch the strips coupled on the two side tubes to finish fastening.

According to an embodiment of the invention, each strip is made of PVC with two ends fastened to the strip by high-frequency welding to form the coupling openings. To facilitate stretching and coupling on the two side tubes, the strips are submerged in hot water for heating and softening. Another two ends of the two side tubes opposite to the coupling tube can be expanded through a pneumatic cylinder driving machine to couple with the support tube. The two side tubes also have respectively an insertion hole on corresponding sides for holding the support tube.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1 through 5 are schematic views showing fastening process of a conventional leisure chair.

FIG. 6 is a flowchart of the method of the invention.

FIGS. 7 through 13 are schematic views showing fastening process according to the method of the invention.

FIG. 14 is a schematic view of a preferably embodiment of the invention.

FIG. 15 is a schematic view of another embodiment of the invention.

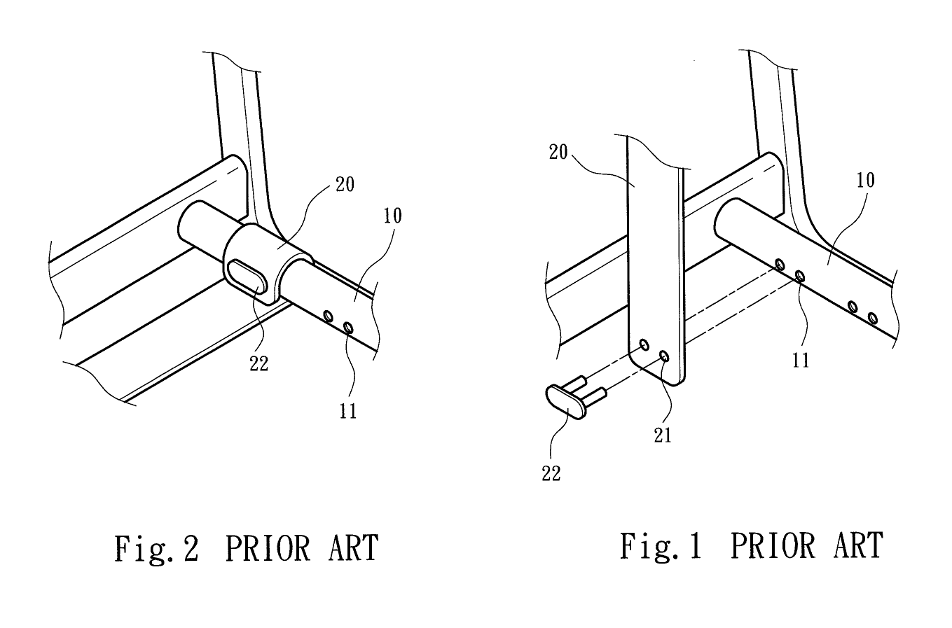

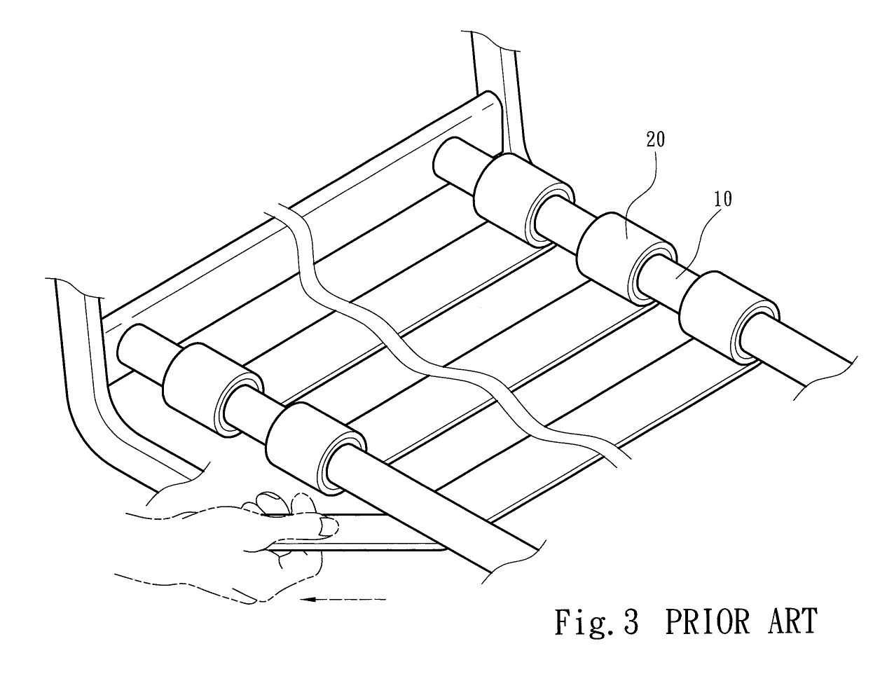

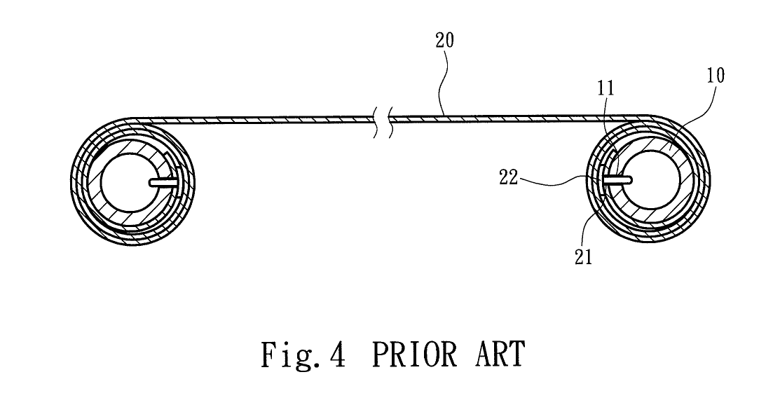

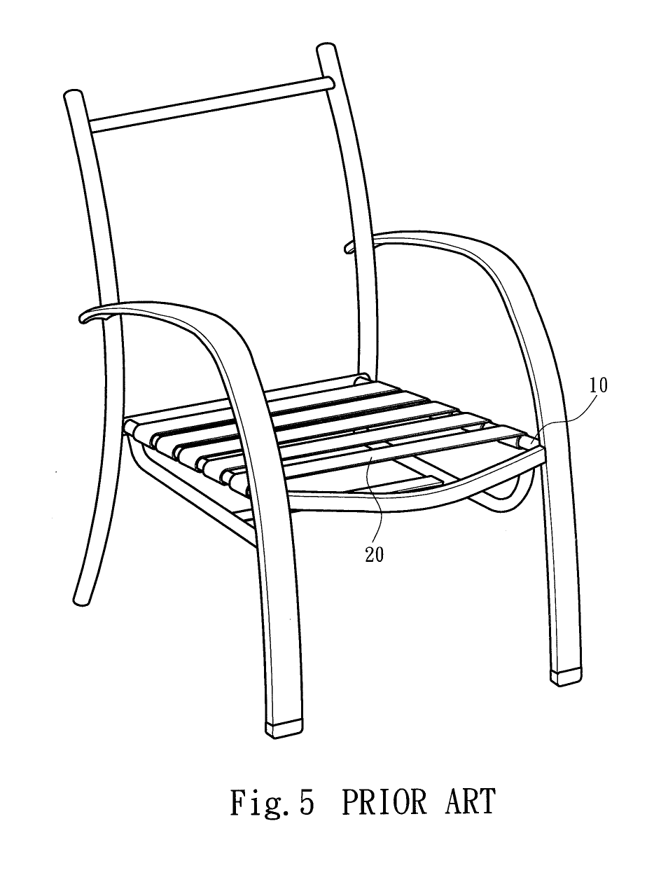

### DETAILED DESCRIPTION OF THE PREFERRED EMBODIMENT

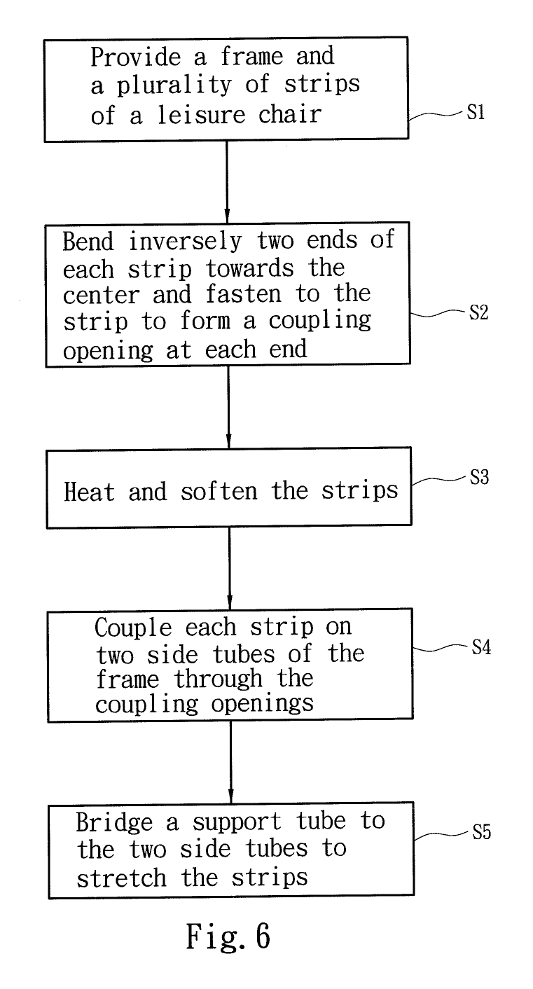

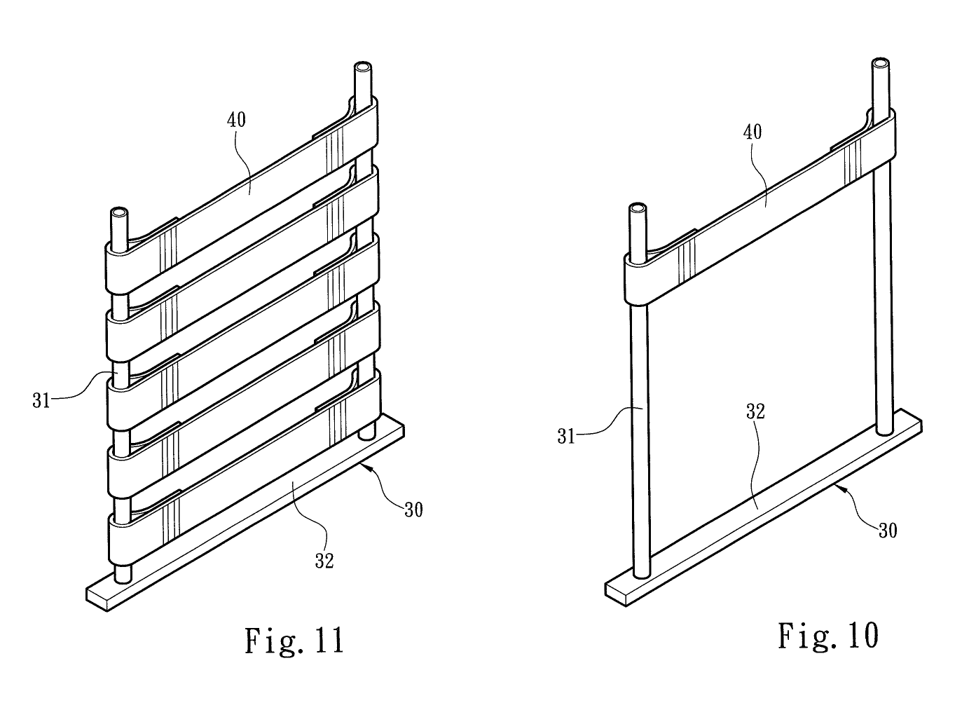

The present invention aims to provide a method for fastening strips to leisure chairs that mainly fastens strips 40 to a leisure chair to support sitting of a user. Please refer to FIGS. 6 through 13, step S1, providing a frame 30 of a leisure chair that can be the integral rack or a portion of the rack of the leisure chair. A portion of the rack is taken for discussion herein, but the frame 30 includes the structure shown in FIG. 10 whether for the integral rack or a portion of the rack. It mainly includes two side tubes 31 with one end connected to a coupling tube 32 and another end formed an opening so that the frame 30 is formed in a U-shaped structure. The coupling tube 32 may be fastened to the two side tubes 31 by soldering, or the two side tubes 31 and coupling tube 32 may be formed integrally and bent to form the frame 30.

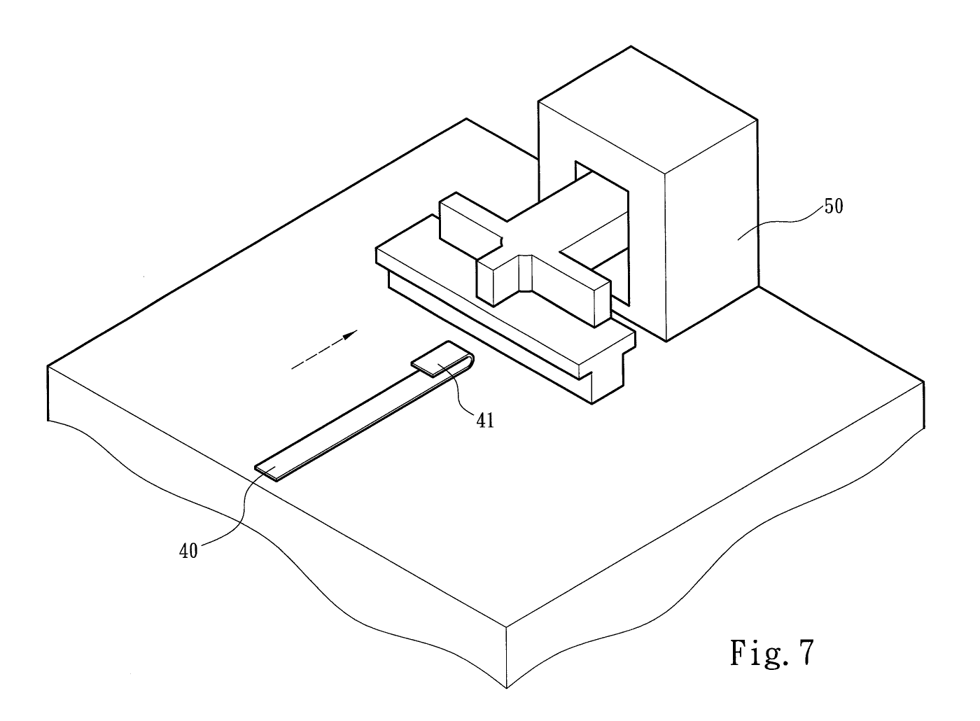

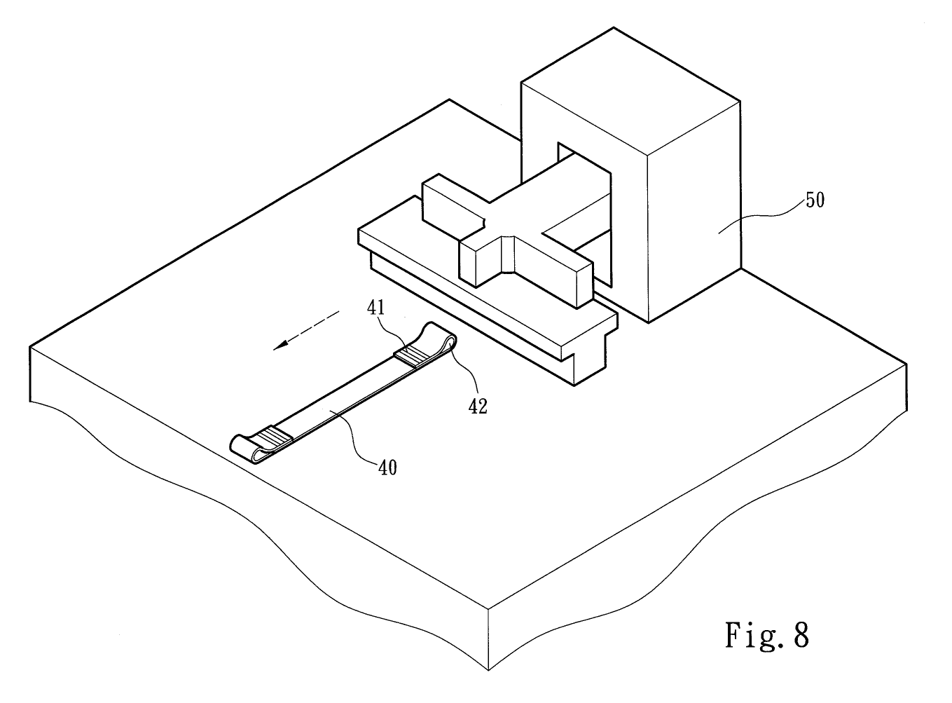

Next, preparing a plurality of elongated strips 40, and each of which is made of PVC. Each strip 40 is formed at a length slightly greater than the interval between the two side tubes 31. Then, proceeding to step S2 to fasten the strips 40 to the frame 30. First, bending inversely two ends 41 of each strip 40 towards the center (as shown in FIG. 7) and fastening the two ends 41 to the strip 40. In an embodiment of the invention, the strip 40 is placed on a high-frequency welding machine 50 to excite the molecules inside the strip 40 and the two ends 41 to interact with each other and generate high temperature to form welding between them so that a coupling opening 42 is formed at each end 41 of the strip 40 through inversely welding (referring to FIG. 8).

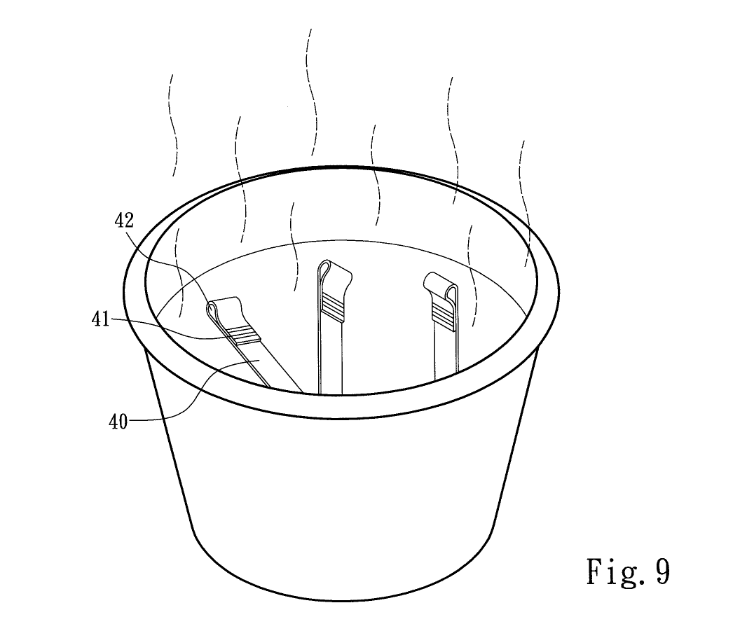

Then proceeding to step S3, submerging the strip 40 with the coupling openings 42 in hot water for heating and softening (referring to FIG. 9); next, proceeding to step S4, coupling the strip 40 on the two side tubes 31 through the coupling openings 42. Because the strip 40 has been heated and softened to produce deformation, it can be coupled on the two side tubes 31 easier (referring to FIG. 10). Each strip 40 is welded and softened as previously discussed, and coupled sequentially on the two side tubes 31 of the frame 30. After the strips 40 between the two side tubes 31 are cooled (referring to FIG. 11), they are contracted elastically to stretch the two side tubes 31. During contraction of the strips 40, as the other two ends of the two side tubes 31 opposite to the coupling tube 32 are formed with openings without being braced, the two side tubes 31 are moved towards each other to shrink the openings.

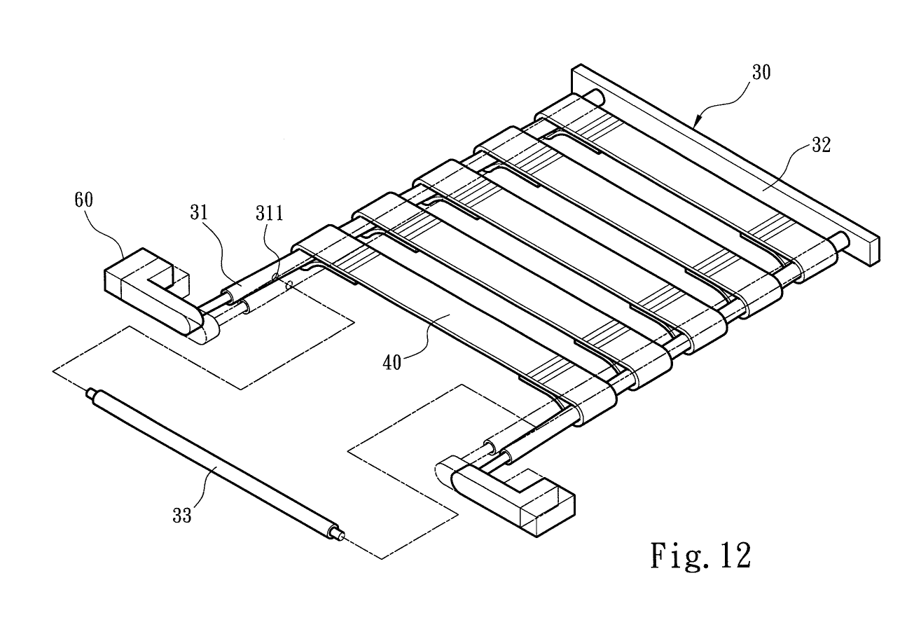

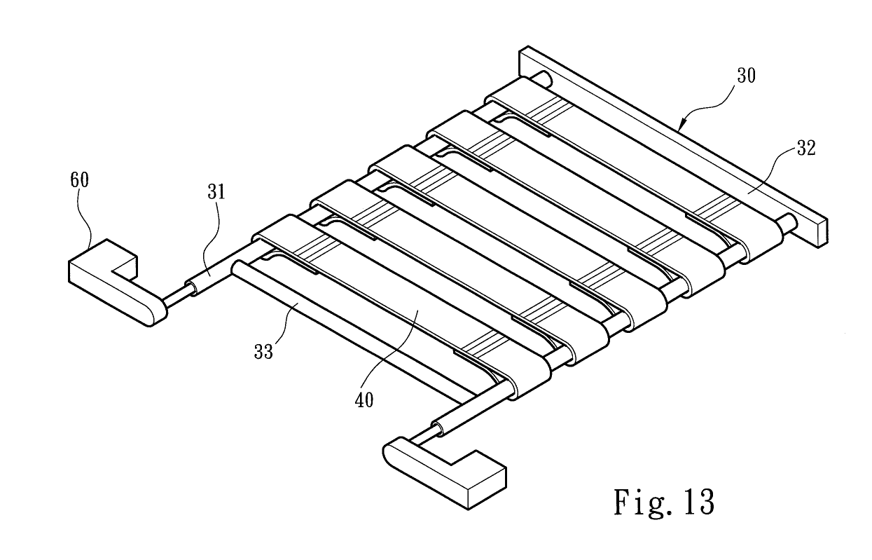

Finally, proceeding to step S5, stretching the two side tubes 31 through a pneumatic cylinder driving machine 60 to return to the original interval between the two side tubes 31 and bridging a support tube 33 to the two side tubes 31. As shown in the drawings, the two side tubes 31 have respectively an insertion hole 311 on two corresponding sides to be inserted by the support tube 33 after the two side tubes 31 are stretched by the pneumatic cylinder driving machine 60. Thereby the two side tubes 31 are braced to stretch the strips 40 (referring to FIG. 12) to finish fastening of the strips 40 (referring to FIG. 13).

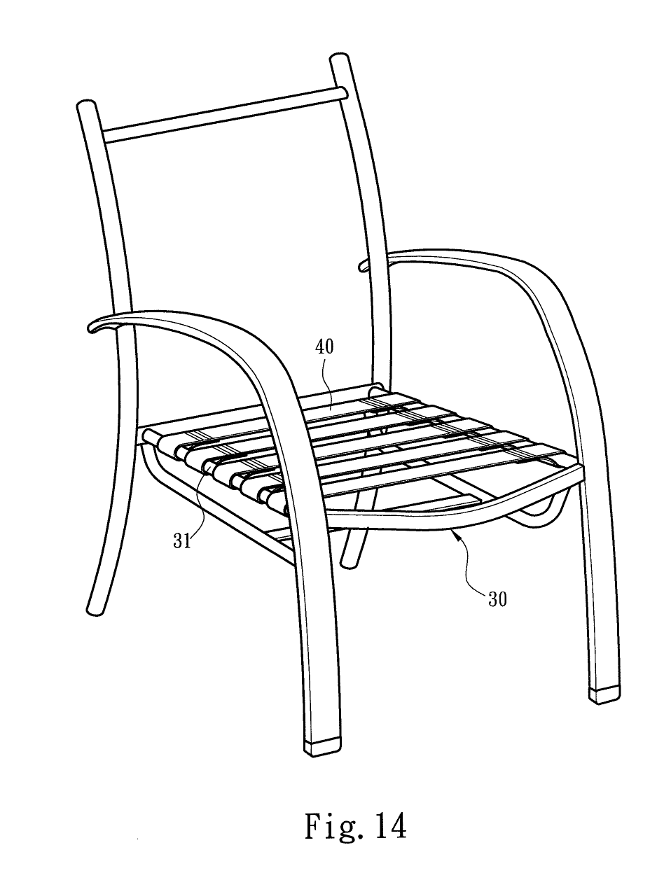

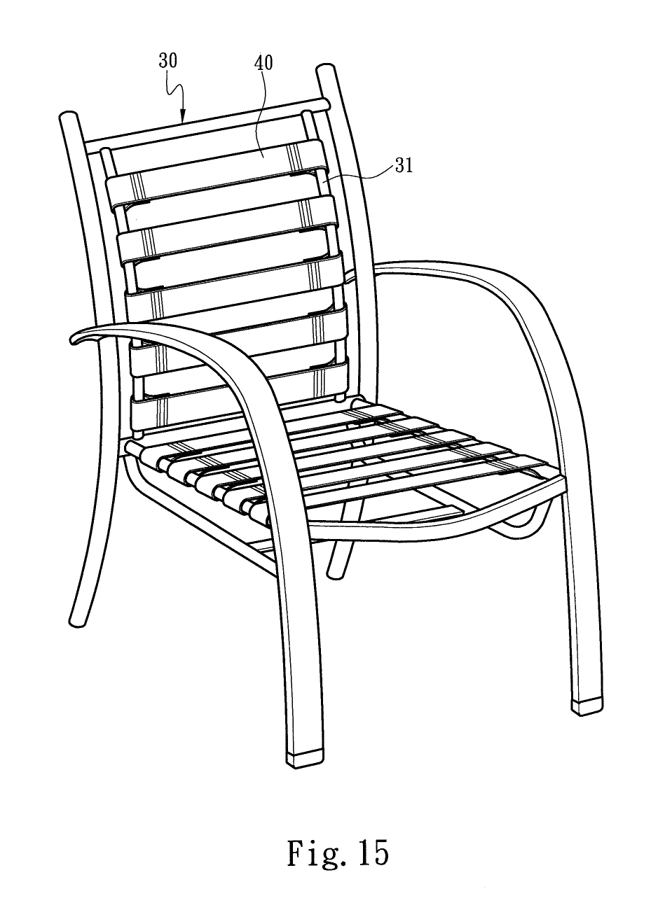

Also referring to FIGS. 14 and 15, the frame 30 with the strips 40 fastened thereon can be coupled with other racks to form a leisure chair, and the frame 30 fastened with the strips 40 can serve as a seat or a backrest of the leisure chair.

In short, the invention mainly changes the conventional winding and fastening approach by forming the coupling openings 42 at two ends of each strip 40 first, and then the strip 40 is heated and softened to directly couple on the two side tubes 31 through the coupling openings 42. Finally, the two side tubes 31 are braced through the support tube 33 to stretch the strips 40 between them. Compared with the conventional technique, the present invention provides many advantages, notably:

1. Assembly can be done quickly to greatly reduce assembling time and increase production speed and quantity of leisure chairs.

2. Each strip 40 receives substantially the same force and forms a uniform tension, thus improves sitting comfort.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for fastening strips to leisure chairs, comprising steps of:
providing a frame and a plurality of strips of a leisure chair, the frame including two side tubes, each of the side tubes including one end connected to a coupling tube;
bending inversely two ends of each strip towards the center of the strip and fastening the two ends to the strip to form a coupling opening at each end;
heating and softening the strip;
coupling the softened strip on the two side tubes through the coupling openings; and
bridging a support tube to another two ends of the two side tubes opposite to the coupling tube to stretch the strips coupled on the two side tubes.

2. The method of claim 1, wherein each strip is fastened through high-frequency welding to form the coupling openings.

3. The method of claim 1, wherein the strip is heated and softened by submerging in hot water.

4. The method of claim 1, wherein the two side tubes are stretched through a pneumatic cylinder driving machine to bridge the support tube.

5. The method of claim 1, wherein the two side tubes respectively include an insertion hole corresponding to each other to be inserted by the support tube.

6. The method of claim 1, wherein the strip is an elongated strip made of PVC.

7. The method of claim 1, wherein the frame is an integral rack of a leisure chair.

8. The method of claim 1, wherein the frame is a portion of a rack of a leisure chair.
